(19) United States
(12) Patent Application Publication
(10) Pub. No.: US 2026/0093285 A1
(43) Pub. Date: Apr. 2, 2026

(54) SCREEN PROTECTOR WITH IN-BUILT MAGNIFICATION

(71) Applicant: Suzanne Michele Catoggio, Howard Beach, NY (US)

(72) Inventor: Suzanne Michele Catoggio, Howard Beach, NY (US)

(21) Appl. No.: 18/900,690

(22) Filed: Sep. 28, 2024

(51) Int. Cl. G06F 1/16; G02B 27/02

(52) U.S. Cl. CPC G06F 1/1637; G02B 27/027

(57) ABSTRACT

Disclosed is a multifunctional screen protector designed to enhance the user experience by integrating multiple advanced features into a single, flexible product. The screen protector incorporates a magnifying lens sheet that provides uniform magnification across the display, aiding users with near-vision difficulties. Additionally, it features an anti-glare coating to improve screen visibility in bright environments, and a blue light-filtering layer to reduce eye strain caused by prolonged exposure to high-energy visible light. To protect user privacy, an embedded privacy filter restricts the viewing angle, making the screen content visible only to the user. The screen protector is adaptable to both flat and curved screens, ensuring broad compatibility with a variety of electronic devices, including smartphones, tablets, and monitors. This invention offers a comprehensive solution that significantly enhances visual clarity, device protection, and user comfort, addressing the limitations of existing screen protectors.

### FIELD OF THE INVENTION

The present invention relates to screen protectors, and more particularly to screen protectors incorporating integrated magnification to aid users with near-vision difficulties in reading digital screens on electronic devices.

### BACKGROUND OF THE INVENTION

With the proliferation of electronic devices such as smartphones, tablets, laptops, and monitors, users are spending increasing amounts of time staring at digital screens. Such prolonged usage often leads to eye strain, discomfort, and exposure to harmful blue light, which may disrupt sleep patterns and affect vision. Additionally, screen visibility in bright environments or under direct sunlight poses significant challenges due to glare and reflections. Many users also face difficulties applying traditional screen protectors onto the display of the electronic device, as they may leave adhesive residue upon removal, fail to provide adequate protection, or are not compatible different type of screens.

Further, users with visual impairments or presbyopia often struggle to read content on smaller screens, which make them use external magnification devices or glasses. This issue creates inconvenience and frustration, particularly for those who frequently switch between tasks or applications on their devices.

Existing screen protectors offer limited solutions to these problems, as they typically focus on either scratch resistance, anti-glare coating functionality, or basic blue light filtering, without providing a comprehensive combination of features. Additionally, most protectors lack built-in magnification, thus requiring users to resort to external aids for improving visibility. Furthermore, many protectors are designed for flat screens only, limiting their usability with curved or irregularly shaped devices.

Therefore, there is a need for a multifunctional screen protector that not only protects screens of electronic device but also enhances user comfort by addressing visual needs, glare reduction, blue light filtering, and ease of application and removal.

### BRIEF SUMMARY OF THE INVENTION

It is an object of the present invention to provide a screen protector with built-in magnification uniformly distributed across the entire surface for enhanced visual clarity.

It is another object of the present invention to reduce screen glare by incorporating an anti-glare coating to increase visibility in bright environments and under direct sunlight.

It is yet another object of the present invention to filter harmful blue light emissions by integrating appropriate coating.

It is further object of the present invention to provide a flexible screen protector design that adheres to both flat and curved screens.

It is another object of the present invention to simplify application and removal of screen protector using a non-residue adhesive.

It is yet another object of the present invention to incorporate an optional privacy filter layer to restrict viewing angles and protect the user's screen privacy.

It is an object of the present invention to enhance screen protector durability by integrating a scratch-resistant layer.

According to an embodiment of the present invention, a screen protector for electronic devices is disclosed. The screen protector comprises a top layer made of transparent material and embedded with a magnifying lens sheet. The screen protector also comprises a bottom layer made of transparent material, the bottom layer being formed with non-residue adhesive on one side. The screen protector further comprises a privacy screen embedding with the top layer. The screen protector further comprises anti-glare coating.

### BRIEF DESCRIPTION OF DRAWINGS

The present invention will become clearly understood to those of ordinary skill in the art when descriptions of exemplary embodiments thereof are read with reference to the accompanying drawings.

FIG. 1 is a schematic view of a screen protector to be placed on a screen of an electronic device according to an embodiment of the present invention.

FIG. 2 is another schematic view of the screen protector of FIG. 1.

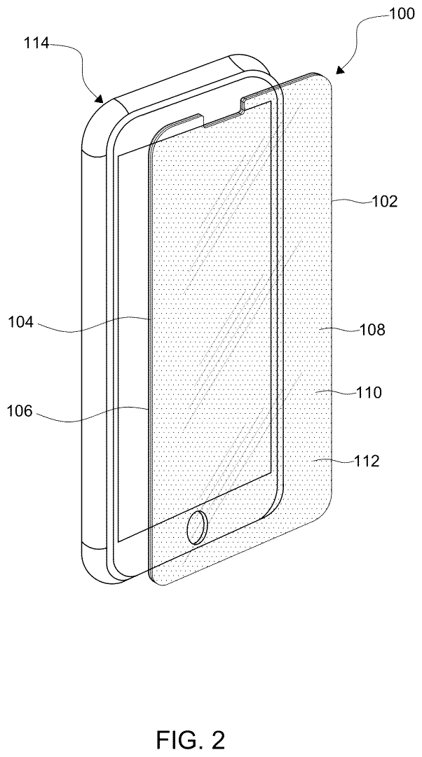

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

The present invention disclosed herein is a screen protector for electronic devices, such as smartphones, tablets, laptop and computer monitors. The screen protector is configured to provide enhanced visibility, protection, and user comfort through integrated magnification, light-filtering capabilities, and scratch resistance.

The present invention disclosed herein is a multifunctional screen protector that integrates a plurality of elements into a single product. This invention provides a comprehensive approach by combining built-in magnification, anti-glare coating, blue light filtering, and privacy protection. The screen protector has a thin, flexible design suitable for both flat and curved screens. The incorporation of a magnifying lens sheet uniformly distributed across the entire surface enables users with near-vision difficulties to view digital screens without the need for additional magnification aids. A magnifying lens sheet is a thin, transparent layer embedded with optical elements that enlarge the visual content displayed on a screen. This sheet can be made from materials such as polycarbonate or acrylic and is designed to uniformly magnify the entire surface area it covers. The magnification strength can vary, typically ranging from +0.05 diopter to +3.5 diopters, but may vary depending on the specific design and user needs. Additionally, the anti-glare coating not only enhances visibility in bright environments but also works synergistically with the blue light filter to reduce eye strain. Furthermore, the optional privacy filter layer adds another dimension of functionality, protecting users'screen content from prying eyes without compromising the other benefits.

While each feature—magnification, anti-glare, blue light filtering, and privacy protection—exists independently in various forms, 'integrating them into one cohesive screen protector required innovative problem-solving in terms of material science and optical engineering. For instance, the challenge of embedding a magnifying lens sheet within a flexible protector that adheres to both flat and curved screens without causing distortion or uneven magnification effects required the development of a novel manufacturing process. This process ensures that the magnification is uniformly distributed across the screen protector.

Moreover, a privacy filter layer that functions effectively without adding significant bulk or reducing the efficacy of the magnification and anti-glare features required careful consideration of the optical properties of the materials used. The specific choice of materials, such as optical-grade polycarbonate for the magnifying lens and PET for the privacy filter helps achieve multiple functionalities within a single, streamlined product.

The privacy filter layer is a specialized film embedded within or applied to a screen protector that narrows the viewing angle of the screen, thereby making it difficult for people outside of a certain range to see the content on the display. This is typically achieved through a micro-louver technology, where microscopic vertical blinds are embedded within the material, ensuring that the screen appears dark or blank when viewed from the side. This layer is often made from transparent materials like polyethylene terephthalate (PET) and is designed to enhance privacy without significantly impacting the user's direct viewing experience.

In addition, the adhesive used in this screen protector is non-residue and allows for repositioning, which enhances the user experience by enabling easy application and removal. This aspect further differentiates the invention from standard screen protectors that often leave residue or lose adhesion after repositioning.

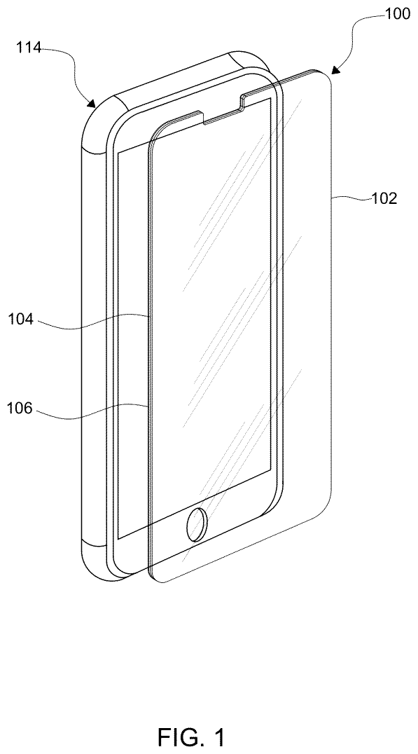

According to an embodiment, a screen protector 100 is disclosed, as shown in FIG. 1, which is to be attached to a smart device 114. The smart device 114 is shown only for illustration purpose, however, any electronic device 114 having a display screen may be used to attach the screen protector 100 thereon. The screen protector 100 comprises a top layer 102 made of a transparent material, wherein the top layer 102 is embedded with magnifying lens sheet 108. The magnifying lens sheet 108 conforms to entire surface of the screen protector 100 for providing consistent visual enhancement across the display and allowing users to comfortably view content on their device 114 without distortion or uneven magnification effects. In one aspect, magnifying lens sheet 108 includes a Fresnel lens sheet made of optical-grade polycarbonate or acrylic. The Fresnel lens is a type of compact lens originally developed for lighthouses, which allows for a large aperture and short focal length without the bulk of a traditional lens. It consists of a series of concentric grooves etched into a thin layer of material, creating a lightweight lens with significant magnification power. In the context of a screen protector 100, the Fresnel lens sheet provides magnification while maintaining a slim profile, allowing it to be integrated seamlessly into the screen protector 100. Polycarbonate has high impact resistance, thus making the screen protector 100 capable of withstanding daily wear and tear while maintaining visual clarity. Acrylic, on the other hand, offers excellent optical properties and can be used in combination with polycarbonate.

The magnification strength of lens is configurable in various diopter strengths, ranging from +0.5 diopters to +3.5 diopters, which can be customized according to user preferences. Thus, the integrated magnification allows users with near-vision difficulties to read text and view images on digital screens without the need for separate reading glasses.

In one aspect, a bottom layer 104 is provided beneath the top layer 102, which is also formed from transparent material to provide structural support and ensure that the screen protector 100 maintains flexibility. The bottom layer 104 is configured with a non-residue adhesive 106 on one side, which allows for easy application and removal of the screen protector 100. In one aspect, the adhesive 106 includes but not limited to ultraviolet adhesives and silicone pressure-sensitive adhesives. These adhesives 106 leave no residue upon removal which helps users to reposition the screen protector 100 or transfer it to another device 114 without any adhesive residue or damage to the underlying screen.

In one embodiment, the top layer 102 is further embedded with a privacy screen 110. The privacy screen 110 is made of transparent Polyethylene terephthalate (PET) layer embedded with louvers.

In one other embodiment, the top layer 102 of the screen protector 100 is configured by applying anti-glare coating instead of embedding a privacy screen 110. This coating reduces reflections caused by ambient light and improves visibility in bright environments. In some configurations, the anti-glare coating is designed to further enhance visibility under direct sunlight, thus providing clear viewing even in outdoor conditions where glare may typically impede screen visibility.

To protect users'eyes from harmful blue light emitted by electronic devices 114, the screen protector 100 also incorporates a blue light-filter coating 112. This coating is integrated within the transparent material to selectively filter wavelengths between 400 nm and 500 nm, thereby reducing exposure to high-energy blue light, which is associated with eye strain and sleep disruption.

The screen protector 100 is flexible in design, such that it adheres to both flat and curved screens. The flexibility of the screen protector 100 allows it to conform to devices with a curvature radius between 1 mm and 10 mm, thus making the screen protector 100 is suitable for a number of electronic devices.

The screen protector 100 is heat-treated for about 1000 degrees and cooled down immediately to make it a scratch-resistant layer, such that the surface of screen protector 100 is protected from physical damage, such as scratches or abrasions, during everyday use. In one embodiment, the scratch-resistant layer is formed as a separate layer, by undergoing aforementioned heating and cooling process, and is bonded on to the top surface. The scratch-resistant layer may be made from materials including, but not limited to, tempered glass, polymer films, and composite laminates. This enhances the durability of the screen protector 100.

Therefore, multi-layer structure of the screen protector 100, consisting of the magnifying lens sheet 108, blue light-filter coatings 112, privacy screen 110 or anti-glare coating, and the scratch-resistant surface, provides improved and enhanced user experience while protecting the screen of the electronic device 114. The non-residue adhesive 106 allows for convenient installation and reusability, while the uniform magnification distribution ensures optimal visual clarity across the entire screen.

To produce the magnifying lens sheet 108, the selected optical-grade material is heated until it becomes pliable and then injected into a custom mold. This mold is specifically designed to shape the material into the desired curvature and magnification level, similar to the design of reading glasses. Once the material is injected and shaped, it is allowed to cool and harden into the form of the magnifying lens sheet 108. The magnifying lens sheet 108 is then laminated onto the bottom layer 104 that serves to provide additional structural support and scratch resistance. This lamination process is performed with great care to prevent air bubbles or imperfections that could interfere with the optical clarity of the screen protector 100.

The built-in magnification feature is especially beneficial for elderly users or those with near-vision difficulties. By providing uniform magnification across the entire screen, users can comfortably read text and view images on their devices 114 without needing external magnifying glasses. This feature is particularly useful for reading small text on smartphones, tablets, or monitors, which can often strain the eyes of individuals with presbyopia or other vision impairments.

Further, the anti-glare coating included in the screen protector 100 significantly enhances screen visibility in bright environments, such as outdoors in direct sunlight. This makes the screen protector 100 ideal for outdoor professionals e.g., construction workers, field researchers or frequent travelers who often use their devices 114 in varying lighting conditions. By reducing reflections and glare, the screen protector 100 allows for clear and uninterrupted viewing of the screen, regardless of the surrounding environment.

The privacy filter embedded within the screen protector 100 is crucial for professionals who handle sensitive or confidential information on their devices 114. In scenarios such as working in public spaces e.g., cafes, airports or during meetings, the privacy filter ensures that only the user can view the screen content, reducing the risk of data breaches or unauthorized viewing. This feature is particularly important for individuals in finance, law, healthcare, or any field that requires strict confidentiality.

The blue light filter helps mitigate eye strain from prolonged screen use, which is a common concern in today's digital age, while the scratch-resistant layer ensures long-term protection of the device's screen.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

This application is intended to cover any adaptations or variations of the present invention. Therefore, it is manifestly intended that this invention be limited only by the claims and the equivalents thereof.

1. A screen protector for electronic devices, comprising:
a top layer made of transparent material and embedded with a magnifying lens sheet; and
a bottom layer made of transparent material, the bottom layer being coated with non-residue adhesive on one side;
wherein the top layer further comprises:
a privacy screen; and
blue light-filter coating.

2. The screen protector of claim 1, wherein the magnifying lens sheet includes Fresnel lens sheet.

3. The screen protector of claim 2, wherein the magnification of Fresnel lens sheet ranging from +0.5 diopter to +3.5 diopter.

4. The screen protector of claim 1, wherein the magnifying lens sheet is made of optical-grade polycarbonate or acrylic.

5. The screen protector of claim 1, wherein the privacy screen is embedded with the top layer.

6. The screen protector of claim 1, wherein the blue light-filter coating filters harmful wavelengths between 400 nm and 500 nm.

7. The screen protector of claim 1 is configured to be repositionable without loss of adhesion.

8. The screen protector of claim 1, wherein the top and bottom layers are made of flexible polymers to adhere to both flat and curved screens of electronic device.

9. The screen protector of claim 8, wherein the flexibility allows the screen protector to conform to electronic devices with screens having a curvature radius between 1 mm and 10 mm.

10. The screen protector of claim 1 wherein the privacy screen layer is made of transparent Polyethylene terephthalate (PET) embedded with louvers.

11. The screen protector of claim 1 further comprises anti-glare coating instead of embedding privacy screen with the top layer.
